(19) United States
(12) Patent Application Publication
(10) Pub. No.: US 2011/0284580 A1
(43) Pub. Date: Nov. 24, 2011

(54) Stand for elevating a dispenser type container

(76) Inventor: Lorraine Marie Boettcher, Sweet Home, OR (US)

(21) Appl. No.: 12/800,563

(22) Filed: May 18, 2010

(51) Int. Cl. B67D 7/84

(52) U.S. Cl. 222/108; 222/185.1

(57) ABSTRACT

A Stand for Elevating a Dispenser Type Container for elevating a container having a product dispensing valve, such as a laundry detergent container, includes a box for elevating the container in an orientation that permits dispensing of a product from the container without manipulation of the container itself. The product dispensing valve sits in an orientation that also permits dispensing of a product from the container over a drip tray that is an integrated part of the Stand for Elevating a Dispenser Type Container.

### BACKGROUND

The present invention relates generally to a Stand for Elevating a Dispenser Type Container for raising and supporting a large volume liquid detergent container and other similar type containers above or adjacent to a washing machine or placed in a cupboard for convenient dispensing of the liquid from the container.

Buying in Bulk has its advantages but buying bulk liquid laundry detergent or other liquids with a similar container has the disadvantages of size and weight. Additionally, the drip which inevitably ensues tends to make a mess where one should not be. None of the prior art addresses BOTH the issue of making the liquid easier to dispense AND catching the drips from the dispenser.

In making the present invention, it was determined the box portion (27) had to be large enough to provide stability for the somewhat heavy dispenser yet small enough to fit in a standard 12″ deep overhead cupboard as typically seen in a laundry room. It was also determined that using materials other than plastic or Plexiglas does not provide the same benefits as those gained by using the plastic or Plexiglas.

It was additionally determined that the drip tray (26) should be large enough to allow the dispenser cup to sit on the drip tray itself. An added benefit of which is how it answers the need for those who are one-handed to easily dispense their laundry detergent.

### SUMMARY

The present invention involves a Stand for Elevating a Dispenser Type Container for raising a container having a product dispensing valve a height which is adequate enough to allow the manufacturer provided dispensing cup to easily clear the valve. Additionally, there is a tray portion (26) to catch any soap and water drips that may ensue.

In the preferred embodiment, the stand is placed on a shelf or in a cupboard where, designed with closing the cupboard door in mind, the dispenser sits on the box part of the stand (27) with the spout over the drip tray (26) in readiness for dispensing the soap.

In an alternate embodiment, the stand is mounted to the wall using a wide plated mounting bracket, like the one shown in FIG. 2a and FIG. 2b thus allowing the dispenser to sit on the platform of the stand (20) at whatever height suits the user, whether the very tall, the average person or the little person.

In either embodiment, the Stand for Elevating a Dispenser Type Container can be used in applications other than the laundry room. For example, many people recycle the container having a product dispensing valve for use in garages, shops, etc.

In either embodiment, the stand can be made of Plexiglas or molded plastic and can be in a variety of colors with or without other prints or patterns as the choice of color or designs does not affect the function of the Stand for Elevating a Dispenser Type Container.

As a result of the present invention, a means is provided for:
1. Raising the heavy liquid dispensing container to allow ease of use by not requiring the additional manipulation of the dispensing container in order to gain access to the dispensing valve, and,
2. Supporting the heavy liquid dispensing container on a wall mounted stand using a bracket (FIGS. 2a & 2b) with a platform (30) to allow ease of use by not requiring the additional manipulation of the liquid dispensing valve.
3. In either embodiment, a drip tray (26) is provided to catch the drips of soap that may occur at the dispensing valve.
4. Storage of small items such as small scrub brushes, bleach pens, etc., inside the open end (front) of the box, thus providing additional storage space that would otherwise not be available.
5. Those who have the use of only one hand to be able to dispense the liquid without the necessity to manipulate the container or worse, dispensing the soap directly into the washing machine without having the opportunity to measure it using the cup.

### BRIEF DESCRIPTION OF DRAWINGS

FIG. 1 is an isometric view of a Stand for Elevating a Dispenser Type Container for raising and supporting a liquid detergent container with a product dispensing valve, formed in accordance with the present invention.

FIG. 2a is a front view of the wide platform bracket needed for the alternate embodiment of the wall mounted Stand for Elevating a Dispenser Type Container.

FIG. 2b is a side view of the wide platform bracket needed for the alternate embodiment of the wall mounted Stand for Elevating a Dispenser Type Container.

### DETAILED DESCRIPTION

The present invention is a Stand for Elevating a Dispenser Type Container made out of Plexiglas joined where each piece makes a 90° angle or it may be made of molded plastic. The box portion (27) is designed to raise a container having a product dispensing valve a height which is adequate enough to allow the manufacturer provided dispensing cup to easily clear the valve. Additionally, there is a tray portion (26) of the Stand for Elevating a Dispenser Type Container which is designed to catch any soap and water drips that may ensue.

In the preferred embodiment, the Stand for Elevating a Dispenser Type Container is placed on a shelf or in a cupboard. A key feature was to make sure the stand was sized to fit inside a cupboard while allowing the cupboard door to close. Additionally, it had to be sized large enough to provide adequate support for a full container.

In the alternate embodiment, the Stand for Elevating a Dispenser Type Container's bolt holes (24) match up with the bolt holes (34) on the wide plated bracket (FIGS. 2a & 2b). The bracket is first mounted to the wall or other hard vertical surface using the screw holes provided (32). The angled support (33) that is attached to the plate (30) and back of the bracket (31) provides added support for the container.

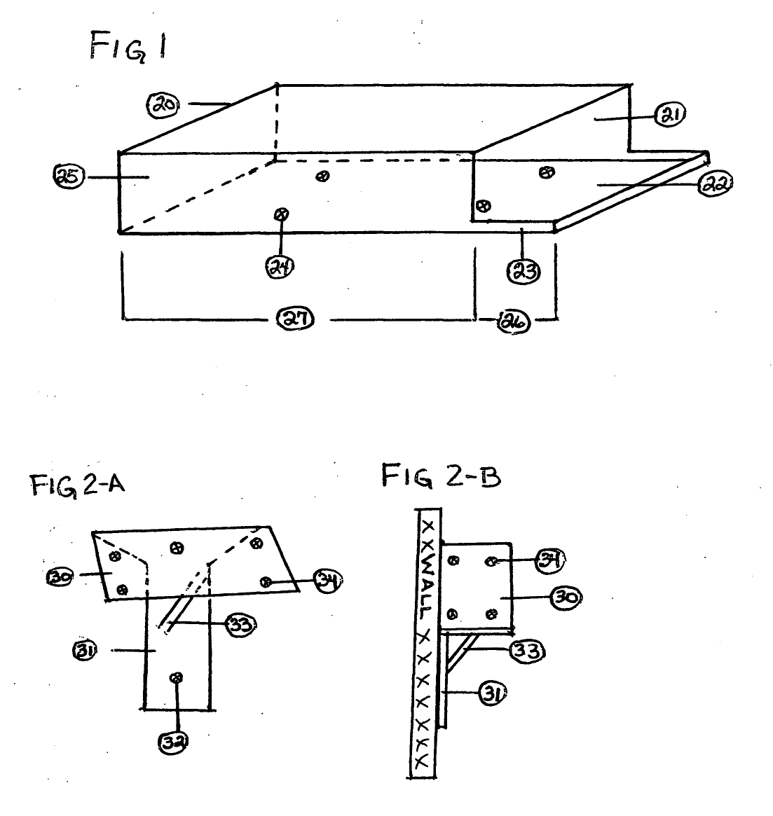

In either embodiment, the Stand for Elevating a Dispenser Type Container (FIG. 1) is the same. It has a top (20) which makes 90° angles with the sides (21) and back (25) which in turn make 90° angles with the bottom (22). The sides (21) are cut (Plexiglas) or molded (plastic) to provide a small lip (23) which makes the tray (26) portion of the Stand for Elevating a Dispenser Type Container. There is no front piece which means the box portion (27) is open on the front creating a small storage box for items such as bleach pens and small scrub brushes.

This invention is an improvement over the Prior Art which did not address the issue of BOTH the ability to dispense the liquid from the container without manipulating the container to be able to use the manufacturer provided dispenser/measure cup AND the containment of any drips of soap and water which may ensue due to the drips that are commonly a problem with the container with a liquid dispensing valve and the water which is commonly the result of rinsing the dispensing cup after each use.

During testing of the prototype it was further observed that the placement of the container on the Stand for Elevating a Dispenser Type Container (FIG. 1) allows for the dispensing and pouring of the soap as well as rinsing of the dispensing cup all with one hand. This was an unexpected benefit of the Stand for Elevating a Dispenser Type Container.

### DRAWINGS

### FIG. 1—Stand

20 Top Panel
21 Side Panel
22 Bottom Panel
23 Lip of Side Panel
24 Bolt Holes (To match up with item 34 of FIGS. 2A & 2B)
25 Back Panel
26 Defines the Tray Portion
27 Defines the Box Portion

### FIGS. 2A and 2B—Stand Bracket

30 Top Plate
31 Back Plate
32 Mounting Screw Holes
33 Support Bar
34 Bolt Holes (To match up with item 24 of FIG. 1)

What is claimed is:

1. A Stand for Elevating a Dispenser Type Container for raising a container having a product dispensing valve, the stand comprising of a box portion (27) to support the container and a tray portion (26) to catch the soap and water drips as well as raise the container up to allow for use of the product dispensing cup without manipulation of the container itself.

2. A Stand for Elevating a Dispenser Type Container as defined in claim 1 above allows the user to use only one hand as accomplished by setting the cup on the drip tray then, using the same hand depress the valve allowing the liquid in the container to flow into the cup. Once filled, with the same hand, pour the liquid and place the emptied cup back on the dispenser or place on drip tray until next use.

3. A Stand for Elevating a Dispenser Type Container as defined in claim 1 and mounted on the wall will provide the same benefits as described in claim 1 and claim 2 as well as freeing up counter or cupboard space.

4. A Stand for Elevating a Dispenser Type Container as defined in claim 1 and mounted on the wall using the bracket (FIGS. 2a & 2b) will provide the same benefits as described in claims 1, 2, and 3 as well as allowing the user to mount the dispenser on the wall at a height that best accommodates the user especially those who are very short or very tall.

5. A Stand for Elevating a Dispenser Type Container as defined in claim 1 and further described in claims 2, 3, and 4 allows this same Stand for Elevating a Dispenser Type Container to be used in applications other than the laundry room such as the use of recycled product dispensing containers in garages, shops, etc.

6. A Stand for Elevating a Dispenser Type Container as defined in claim 1 is dishwasher safe.
